(19) United States
(12) Patent Application Publication
(10) Pub. No.: US 2026/0039738 A1
(43) Pub. Date: Feb. 5, 2026

(54) MYOELECTRIC SIGNALS ACQUISITION APPARATUS, METHOD FOR CONTROLLING MYOELECTRIC SIGNALS ACQUISITION APPARATUS, AND ELECTRONIC DEVICE

(71) Applicant: GOERTEK INC., Shandong (CN)

(72) Inventors: XIANGJIN CHEN, Shandong (CN); Yang Yu, Shandong (CN)

(73) Assignee: GOERTEK INC., Shandong (CN)

(21) Appl. No.: 18/996,922

(22) PCT Filed: Aug. 8, 2023
(86) PCT No.: PCT/CN2023/111693

§ 371 Date: Jan. 17, 2025

(30) Foreign Application Priority Data
Aug. 12, 2022 (CN) 202210970430.0
Aug. 12, 2022 (CN) 202210970444.2

(51) Int. Cl. H04M 1/72409; G06F 3/01

(52) U.S. Cl. CPC H04M 1/724095; G06F 3/015

(57) ABSTRACT

The disclosure provides a myoelectric signals acquisition apparatus, a method for controlling a myoelectric signals acquisition apparatus, and an electronic device. The method comprises: obtaining the myoelectric signals from a plurality of positions on a wrist; determining whether a motion holding state is present, based on the myoelectric signals; determining whether the myoelectric signals contain motion information when in the motion holding state; obtaining a corresponding control motion based on the myoelectric signals when the myoelectric signals contain the motion information; and generating a control signal based on the control motion to control a target device.

### CROSS-REFERENCE TO RELATED APPLICATIONS

The present disclosure is a National Stage of International Application No. PCT/CN2023/111693, filed on Aug. 8, 2023, which claims priority to Chinese Patent Applications No. 202210970430.0 and No. 202210970444.2 both filed on Aug. 12, 2022, all of which are hereby incorporated by reference in their entireties.

### TECHNICAL FIELD

The present disclosure relates to the technical field of intelligent control, and particularly to a myoelectric signals acquisition apparatus, a method for controlling a myoelectric signals acquisition apparatus, and an electronic device.

### BACKGROUND

In scenarios such as cycling, driving and joystick operation, a user often needs to maintain a grip on a physical object. At this point, if the user uses a cell phone, such as answering a call or switching the music played on the cell phone, the user needs to release his/her grip on the object in order to operate the cell phone. This type of operation brings inconvenience to the user.

### SUMMARY

An objective of the present disclosure is to provide a new technical solution for acquiring myoelectric signals.

According to a first aspect of the present disclosure, a method for controlling a myoelectric signals acquisition apparatus is provided. The method comprises:
obtaining myoelectric signals from a plurality of positions on a wrist;
determining whether the myoelectric signals indicate a motion holding state;
when in the motion holding state, determining whether the myoelectric signals contain motion information;
when determining that the myoelectric signals contain motion information, obtaining a corresponding control motion based on the myoelectric signals; and
generating a control signal based on the control motion to control a target device.

According to a second aspect of the present disclosure, a myoelectric signals acquisition apparatus is provided. The apparatus utilizes the control method described in the first aspect of the present disclosure and comprises a myoelectric signals acquisition circuit, and the circuit comprises:
an amplification circuit, a conversion circuit, a processor, and a communication circuit;
the amplification circuit is configured for receiving myoelectric signals and generating an amplified signal based on the myoelectric signals;
the conversion circuit comprises an analog-to-digital converter, a first end of which is configured for receiving the amplified signal, and a second end of which is configured for outputting a digital signal generated by the analog-to-digital converter based on the amplified signal;
a first end of the processor is configured for receiving the digital signal, and a second end of the processor is configured for outputting a control signal generated by the processor based on the digital signal;
the processor is configured for determining whether the myoelectric signals indicate a motion holding state; when in the motion holding state, determining whether the myoelectric signals contain motion information; when determining that the myoelectric signals contain motion information, obtaining a corresponding control motion based on the myoelectric signals; generating a control signal based on the control motion;
a first end of the communication circuit is configured for receiving the control signal, and a second end of the communication circuit is configured for sending the control signal to a target device.

According to a third aspect of the present disclosure, an electronic device is provided, which comprises a processor and a memory, the memory storing a program or an instruction executable by the processor, the program or instruction, when executed by the processor, being capable of achieving the method for controlling a myoelectric signals acquisition apparatus according to the first aspect.

According to an embodiment of the present disclosure, by acquiring myoelectric signals from a plurality of positions on a wrist and controlling the target device according to the motion information contained in the myoelectric signals in the motion holding state, the present disclosure does not require the user to release his/her grip on a held object. Consequently, the user can control the target device while maintaining his/her hold on the object, thereby enhancing the convenience of the user's operation.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which are incorporated in the description and constitute a part of the description, illustrate embodiments of the present disclosure and, together with the description thereof, serve to explain the principles of the present disclosure.

FIG. 1 is a flowchart of a method for controlling a myoelectric signals acquisition apparatus of the present disclosure.

FIG. 2 is a modular diagram of a myoelectric signals acquisition circuit of the present disclosure.

FIG. 3 is a modular diagram of an amplification circuit of the present disclosure.

FIG. 4 is a schematic diagram of a first amplification circuit of the present disclosure.

FIG. 5 is a schematic diagram of a first filter circuit of the present disclosure.

FIG. 6 is a schematic diagram of a second amplification circuit of the present disclosure.

FIG. 7 is a schematic diagram of a right-leg circuit of the present disclosure.

FIG. 8 is a schematic diagram of a myoelectric signals acquisition apparatus of the present disclosure.

FIG. 9 is a schematic diagram of circuit connections in the myoelectric signals acquisition apparatus of the present disclosure.

### DETAILED DESCRIPTION

Various exemplary embodiments of the present disclosure will now be described in detail with reference to the accompanying drawings. It is to be noted that unless otherwise specified, the relative arrangements, numerical expressions and values of components and steps illustrated in the embodiments do not limit the scope of the present disclosure.

The description of at least one exemplary embodiment is for illustrative purpose only and in no way implies any restriction on the present disclosure, its application, or use.

Techniques, methods and devices known to those skilled in the prior art may not be discussed in detail; however, such techniques, methods and devices shall be regarded as part of the description where appropriate.

In all the examples illustrated and discussed herein, any specific value shall be interpreted as illustrative rather than restrictive. Therefore, other examples of the exemplary embodiments may have different values.

It is to be noted that similar reference numbers and alphabetical letters represent similar items in the accompanying drawings. Once an item is defined in one drawing, further reference to it may be omitted in subsequent drawings.

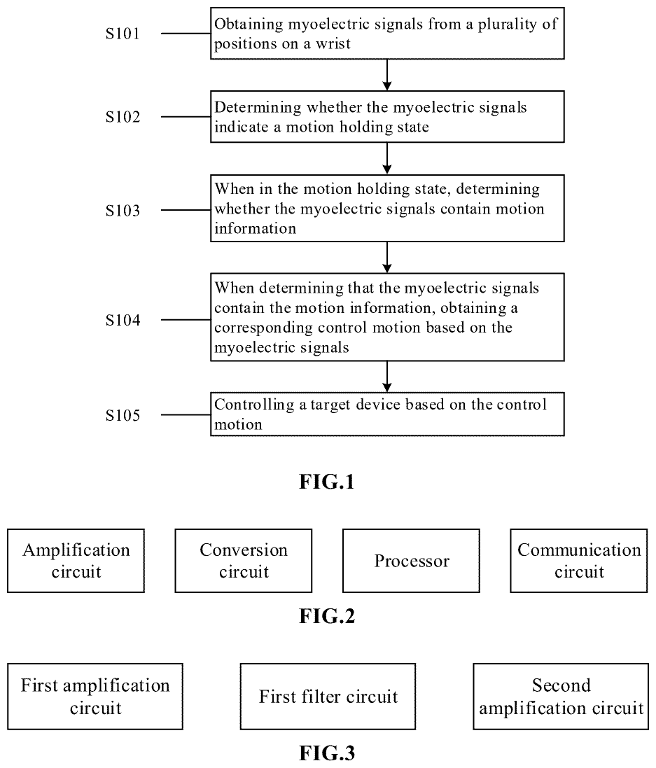

As shown in FIG. 1, an embodiment of the present disclosure introduces a method for controlling a myoelectric signals acquisition apparatus. The method comprises steps S101-S105.
S101: obtaining myoelectric signals from a plurality of positions on a wrist.

The present disclosure acquires the myoelectric signals by means of the myoelectric signals acquisition apparatus. The user wears the myoelectric signals acquisition apparatus on the wrist, i.e., the wrist area. The myoelectric signals acquisition apparatus may acquire the myoelectric signals at a plurality of positions on the user's wrist.

There are a plurality of muscles in the arm that work together to control the stretching, bending, swaying, and other movements of the fingers. The myoelectric signals acquisition apparatus contains a plurality of sets of electrodes and may acquire myoelectric signals from different muscles. The myoelectric signals acquired by different electrodes can be combined to reflect the movement state of the muscles, and thus can reflect the current gesture.
S102: determining whether the myoelectric signals indicate a motion holding state.

A motion holding state is a state in which the hand is held in motion by the muscles of the hand. In scenarios such as riding, driving or AR handle control, the user's hand will enter the motion holding state from a relaxed state. For example, when the user's hand holds the steering wheel of the vehicle, the hand is in the motion holding state. When the user's hand is released from the steering wheel of the vehicle, the hand is changed from the motion holding state to the relaxed state.
S103: when in the motion holding state, determining whether the myoelectric signals contain motion information.

The motion information may be generated by the force exerted by the user's finger, and may be generated by the force exerted by one finger or by a plurality of fingers. For example, when the user's hand holds the steering wheel of the vehicle, if one finger of the user exerts force, the corresponding myoelectric signals containing the motion information will be generated.
S104: when determining that the myoelectric signals contain motion information, obtaining a corresponding control motion based on the myoelectric signals.

The control motion is performed by the user in the motion holding state. For example, when the user's hand holds the steering wheel of the vehicle, the hand is in the motion holding state. If the user exerts force with his fingers while holding the steering wheel of the vehicle, the control motion means that the user exerts force with his fingers, which may specifically refer to “exerting force by the left index finger”, “exerting force by the left middle finger”, or other motions.
S105: generating a control signal based on the control motion to control a target device.

Different control motions can control the target device to perform different functions. Pre-storing the corresponding relationship between the control motion and the target device control signal, obtaining the corresponding target device control signal after obtaining the control motion, and sending the acquired target device control signal to the target device, so as to complete the control on the target device. For example, when the target device is a mobile phone, the control motion is “exerting force by the left index finger”, and the corresponding target device control signal is “answering a call”; the control motion is “exerting force by the left middle finger”, and the corresponding target device control signal is “rejecting a call”. When the mobile phone is called, the user can use the left index finger to answer the call, and can also use the left middle finger to reject the call.

By acquiring the myoelectric signals of a plurality of positions of the wrist when the user's hand holds the object, and by completing the control on the target device through the myoelectric signals, the present disclosure does not require the user to release his/her grip on a held object. Consequently, the user can control the target device while maintaining his/her hold on the object, thereby enhancing the convenience of the user's operation.

In an implementation of the present disclosure, step S102 includes: obtaining a first window signal from the myoelectric signals through a sliding window; calculating a first mean value of amplitudes and a first zero-crossing rate of the first window signal; if the first mean value exceeds a first threshold and the first zero-crossing rate exceeds a second threshold, it is determined to be in the motion holding state.

In scenarios such as cycling, driving or AR handle operation, the user's hand goes from a relaxed state to the motion holding state. In the relaxed state, the amplitude of myoelectric signals generated by the human body is low, similar to noise signals. However, in the case of grasping and the like, because muscles participate in the motion holding, myoelectric signals containing muscle motion information of a certain amplitude are generated in the frequency domain of 20-500 Hz according to different use forces. The magnitude of the myoelectric signals is greater in the motion holding state than in the relaxed state.

In order to identify whether the motion is held after grasping, the mean value and the zero-crossing rate of each channel of the myoelectric signals can be calculated, wherein the mean value can reflect the strength of the current muscle, and the zero-crossing rate can partially reflect the activity of the muscle. The zero-crossing rate represents the number of times per second that a signal passes through zero. The first window signal is obtained through the sliding window, and the first mean value and the first zero-crossing rate are calculated according to the first window signal. Determining whether the hand is in the motion holding state according to the preset first threshold and second threshold. If the first mean value exceeds the first threshold value and the first zero-crossing rate exceeds the second threshold value, it is determined that the hand is in the motion holding state; otherwise, it is determined that the hand is not in the motion holding state. If it is determined that the hand is in the motion holding state, it is possible to mark the current state and track it in real time.

In an implementation of the present disclosure, step S103 includes: obtaining a second window signal from the myoelectric signals through the sliding window; calculating a second mean value of amplitudes and a second zero-crossing rate of the second window signal; if the second mean value exceeds a third threshold and the second zero-crossing rate exceeds a fourth threshold, determining that the myoelectric signals contain motion information

In the motion holding state, when a finger exerts force, an instantaneous energy waveform with a large amplitude change will be generated in the time domain, which contains muscle motion information and can describe the current motion state.

In the motion holding state, obtaining a second window signal from the myoelectric signals through the sliding window. The second window signal is a signal subsequent to the first window signal in chronological order, such as a sliding interval between the second window signal and the first window signal. The second mean value and the second zero-crossing rate are calculated from the second window signal. Determining whether the myoelectric signals contain the motion information according to the preset third threshold and fourth threshold. If the second mean value exceeds the third threshold and the second zero-crossing rate exceeds the fourth threshold, it is determined that the myoelectric signals contain motion information, otherwise it is determined that the myoelectric signals do not contain motion information.

In an implementation of the present disclosure, before step S102, further including: estimating noise of the myoelectric signals to obtain an initial noise value; performing a fast Fourier transform on the myoelectric signals and calculating a signal-to-noise ratio based on a fast Fourier transform result and the initial noise value; calculating a denoising coefficient based on the signal-to-noise ratio; removing noise from the myoelectric signals based on the denoising coefficient.

The myoelectric signals are the cumulative result of electrical signals from individual muscle fibers and represent a standard superimposed signal. When the hand is in a gripping state, the myoelectric signals tend to have significant noise, which overlays onto the motion. It is possible to identify noise through spectral analysis, and perform denoising on the myoelectric signals, thereby greatly improving identifying accuracy.

During denoising the myoelectric signals, the sliding window can be used to obtain a plurality of window data from the myoelectric signals, so that each window data can be denoised in turn. Specifically, the sampling rate, the sliding window are initialized, and a window data is obtained from the myoelectric signals through the sliding window. Noise estimation is performed on the above window data to obtain the noise initial value corresponding to the window data. The acquired myoelectric signals are time-domain signals, and a fast Fourier transform (FFT) operation is performed on the window data to transform the signals from the time domain to the frequency domain, and a signal-to-noise ratio of the window data is calculated based on the fast Fourier transform result and the noise initial value. The denoising coefficient is calculated based on this SNR, and the higher the SNR, the smaller the denoising coefficient. Noise elimination is performed on the window data by the denoising coefficient, and specifically, a corresponding component of noise is subtracted from the window data. An Inverse Fast Fourier Transform (IFFT) is performed on the denoised window data, so as to reduce the signal to the time-domain signal, which is a signal corresponding to the above-described window data with the noise removed. Based on the data with the noise removed corresponding to all the window data, it is possible to obtain the denoised myoelectric signals.

In an implementation of the present disclosure, step S104 includes: performing dimensionality expansion on the myoelectric signals to obtain dimensionality-expanded myoelectric signals; obtaining a corresponding control motion based on the dimensionality-expanded myoelectric signals.

The acquired myoelectric signals can be represented by a one-dimensional array. However, the interpretability of these myoelectric signals is relatively poor, and they contain limited directly extractable motion information, making them difficult to interpret. Therefore, dimensionality expansion can be applied to the myoelectric signals to extract more informative features. The dimensionality-expanded myoelectric signals can be represented by a spatial matrix that contains various motion information.

In the present embodiment, said “performing dimensionality expansion on the myoelectric signals to obtain dimensionality-expanded myoelectric signals”, includes: performing a short-time Fourier transform or wavelet transform on data of each channel of the myoelectric signals to obtain frequency-domain information of the myoelectric signals; obtaining the dimensionality-expanded myoelectric signals based on spatial information of the channels, frequency-domain information of the myoelectric signals, and time-domain information of the myoelectric signals

The acquired myoelectric signals are time-domain signals, so the time-domain information of the myoelectric signals can be obtained. The frequency-domain information of the myoelectric signals can be obtained by performing the transform on the myoelectric signals to transform the time-domain signal to the frequency-domain signal.

The myoelectric signals are acquired by the sampling electrodes on the myoelectric signals acquisition apparatus, and each set of sampling electrodes serves as a channel. In the process of acquiring the myoelectric signals, different sampling electrodes are attached to different positions of the user's body, the myoelectric signals at different positions are acquired, and there is a spatial relationship between various channels. By combining the time-domain information and the frequency-domain information of the myoelectric signals and the spatial information of the channels so as to obtain one spatial matrix containing the time-domain information and the frequency-domain information of the myoelectric signals and the spatial information of the channels, the spatial matrix may be used to represent the dimensionality-expanded myoelectric signals.

In an implementation of the present disclosure, said “obtaining a corresponding control motion based on the dimensionality-expanded myoelectric signals”, includes: recognizing dimensionality-expanded myoelectric signals based on a preset recognition model to obtain the control motion.

The present disclosure includes a pre-set artificial intelligence recognition model, which is used to recognize the control motion contained in the myoelectric signals. After recognizing the control motion, the control motion is mapped into a control signal to control the target device. For example, the target device is a mobile phone, and can be controlled to perform functions such as answering a call, rejecting a call, and switching music. The recognition model is obtained by putting the spatial matrix information transformed by motions in the sample database into a deep learning network for training and learning. By using this recognition model, it is possible to effectively obtain the classification information of the control motions, thereby completing the classification of the motions.

Furthermore, after the recognition model has been established through training and learning, and after accurately recognizing the myoelectric signals in real-time by using the recognition model, the myoelectric signals recognized this time and the recognition results can also be used as learning samples to perform secondary learning on the artificial intelligence recognition model, so as to further optimize the recognition capability of the artificial intelligence recognition model.

In an implementation of the present disclosure, step S101 includes applying a bias voltage to a skin surface: obtaining the myoelectric signals from the plurality of positions on the wrist during applying the bias voltage.

The amplitude of the mvoelectric signals is low, for example, between 0 and 5 mV, and a bias voltage needs to be added to the skin as a DC component of the reference elevation signal. When acquiring the myoelectric signals, a bias voltage is applied to the skin surface first, and then the mvoelectric signals are acquired. After the acquisition of the myoelectric signals is stopped, the application of the bias voltage is stopped.

The embodiment of the present disclosure introduces a myoelectric signals acquisition apparatus, which adopts the control method according to any embodiment of the present disclosure. The apparatus includes a myoelectric signals acquisition circuit, and as shown in FIG. 2, the circuit includes an amplification circuit, a conversion circuit, a processor, and a communication circuit.

The amplification circuit is configured for receiving myoelectric signals and generating an amplified signal based on the myoelectric signals.

Generally, the amplitude of the myoelectric signals is low, for example, the amplitude range of the myoelectric signals is 0-5 mV, and the myoelectric signals need to be amplified to facilitate recognition of the myoelectric signals. The magnification may be hundreds to thousands of times.

The conversion circuit includes an analog-to-digital converter, a first end of which is configured for receiving the amplified signal, and a second end of which is configured for outputting a digital signal generated by the analog-to-digital converter based on the amplified signal.

The acquired myoelectric signals are analog signals, and the analog signals are converted into digital signals through the analog-to-digital converter to facilitate subsequent processing.

A first end of the processor is configured for receiving the digital signal, and a second end of the processor is configured for outputting a control signal generated by the processor based on the digital signal.

The processor is configured for determining whether the myoelectric signals indicate a motion holding state; when in the motion holding state, determining whether the myoelectric signals contain motion information; when determining that the myoelectric signals contain motion information, obtaining a corresponding control motion based on the myoelectric signals; generating a control signal based on the control motion.

The processor is configured for analyzing and processing the received digital signals, recognizing the motion information contained in the myoelectric signals, and generating a corresponding control signal according to the motion information, wherein the control signal is used to control the target device. For example, the target device is a mobile phone, can be controlled to answer or reject the call, and can also be controlled to perform other functions. The processor may be an MCU (Microcontroller Unit) chip.

A first end of the communication circuit is configured for receiving the control signal, and a second end of the communication circuit is configured for sending the control signal to a target device.

The communication circuit forwards the received control signal to the target device, and the target device performs a corresponding function after receiving the control signal.

In the present embodiment, the amplifier circuit is provided to amplify the acquired myoelectric signals, thereby facilitating the recognition of the myoelectric signals.

As shown in FIG. 3, in the embodiment of the present disclosure, the amplification circuit includes a first amplification circuit, a first filter circuit and a second amplification circuit. An input end of the first amplification circuit receives the myoelectric signals, an input end of the first filter circuit is connected to an output end of the first amplification circuit, an input end of the second amplification circuit is connected to an output end of the first filter circuit, and an output end of the second amplification circuit is connected to a first end of the analog-to-digital converter.

The first amplification circuit receives the acquired myoelectric signals, the myoelectric signals are differential signals, and the first amplification circuit can convert the differential signals into single-ended signals and thus can improve anti-interference capability of the signal. The first amplification circuit primarily amplifies the myoelectric signals and outputs a first amplification signal, wherein the first amplification signal is a single-ended signal.

The frequency range of the acquired myoelectric signals is large, for example, the signals in the frequency range of 0 Hz to thousands of Hz can be acquired, and a large number of clutter signals are contained. The frequency range of a valid signal is relatively small, for example, a signal in the frequency range of 20-500 Hz is a valid signal. Through the first filter circuit, the clutter signal can be filtered, and only the valid signal is retained.

The second amplification circuit further amplifies the filtered first amplification signal, and amplifies the signal into the sampling range of the analog-to-digital converter, so as to facilitate acquisition and recognition.

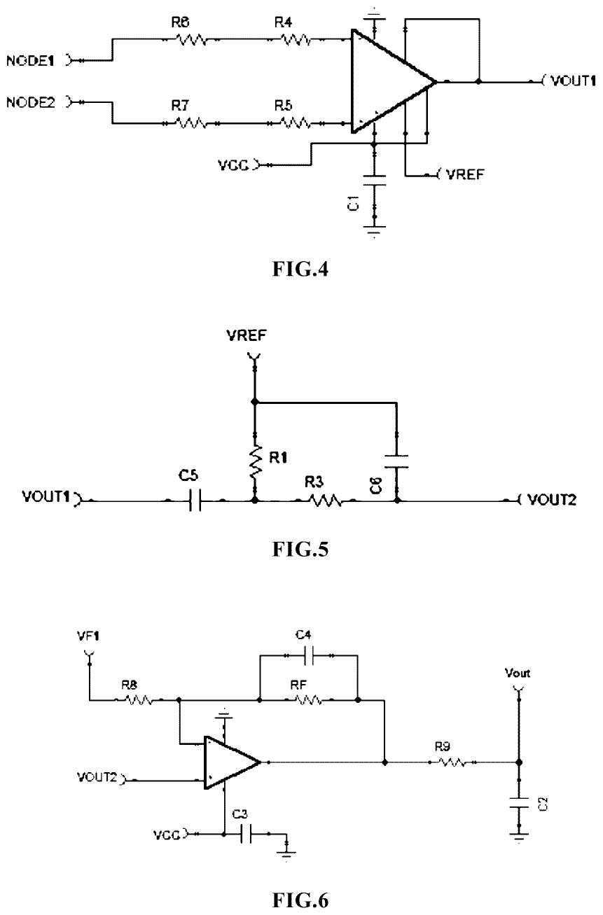

As shown in FIG. 4, the first amplification circuit includes an instrumentation amplifier, a first signal input end NODE1, and a second signal input end NODE2. The first signal input end NODE1 and the second signal input end NODE2 are configured for acquiring myoelectric signals, a first end and a second end of the instrumentation amplifier are respectively connected to the first signal input end NODE1 and the second signal input end NODE2, and an output end of the instrumentation amplifier is connected to an output end VOUT1 of the first amplification circuit.

The first signal input end NODE1 and the second signal input end NODE2 can be metal electrodes, and the metal electrodes corresponding to the first signal input end NODE1 and the second signal input end NODE2 are attached to the user skin when in use. For example, when acquiring the myoelectric signals on the wrist, the metal electrodes corresponding to the first signal input end NODE1 and the second signal input end NODE2 are attached to the user's wrist, and then the myoelectric signals are acquired and transmitted.

As shown in FIG. 4, matching resistors R4 and R6 are provided between the first signal input end NODE1 and the first end of the instrumentation amplifier, and matching resistors R5 and R7 are also provided between the second signal input end NODE2 and the second end of the instrumentation amplifier. The resistors R4 and R6 are connected in series between the first signal input end NODE1 and the first end of the instrumentation amplifier, and the resistors R5 and R7 are connected in series between the second signal input end NODE2 and the second end of the instrumentation amplifier. The matching resistors R4, R5, R6, and R7 are used to match impedance of the circuit.

As shown in FIG. 5, the filter circuit is a band-pass filter circuit, and specifically includes: a first resistor R1, a second resistor R3, a first filter capacitor C5, and a second filter capacitor C6. A first end of the first filter capacitor C5 is connected to the output end VOUT1 of the first amplification circuit, a second end of the first filter capacitor C5 is connected to both a first end of the first resistor R1 and a first end of the second resistor R3, the second filter capacitor C6 is provided between a second end of the first resistor R1 and a second end of the second resistor R3, the second end of the first resistor R1 is connected to a reference voltage input end VREF of the band-pass filter circuit, and the second end of the second resistor R3 is connected to an output end VOUT2 of the band-pass filter circuit.

Since the acquired myoelectric signals contain a large number of clutter signals, only valid signals in the specified frequency range are required for identification, and signals outside the useful bandwidth can be filtered out by the band-pass filter circuit. The band-pass filter circuit receives the output signal VOUT1 of the first amplification circuit and outputs the filtered signal VOUT2.

As shown in FIG. 6, the second amplification circuit includes an operational amplifier, a second filter circuit, a third filter circuit, and a first voltage input end VF1. A first input end of the operational amplifier is connected to the output end VOUT2 of the first filter circuit, a second input end of the operational amplifier is connected to both a first end of the second filter circuit and the first voltage input end VF1, a second input end of the second filter circuit is connected to an output end of the operational amplifier, the output end of the operational amplifier is connected to a first end of the third filter circuit, and a second end of the third filter circuit is connected to the output end VOUT of the second amplification circuit.

The power supply end of the operational amplifier is connected to the second voltage input end VCC, and the power supply end of the operational amplifier is grounded through the capacitor C3.

In the present embodiment, the third filter circuit includes a third resistor R9 and a third capacitor C2. The third filter circuit is a low-pass filter circuit. The first end of the third resistor R9 is connected to the output end of the operational amplifier, the second end of the third resistor R9 is connected to the first end of the third capacitor C2, the second end of the third capacitor C2 is grounded, and the first end of the third capacitor C2 is connected to the output end VOUT of the second amplification circuit.

In the present embodiment, the second filter circuit includes a fourth resistor and a fourth capacitor C4 which are connected in parallel, a first end of the fourth resistor is connected to the second input end of the operational amplifier, and a second end of the fourth resistor is connected to the output end of the operational amplifier.

In the present embodiment, the circuit further includes a right-leg circuit, which is configured for applying a bias voltage to a skin surface.

Due to the low amplitude of the myoelectric signals, in order to effectively amplify the signal, a bias voltage is added to the skin as a reference to boost the DC component of the signal. The myoelectric signals are AC signals and become single-ended signals with a DC bias voltage after passing through the amplification circuit.

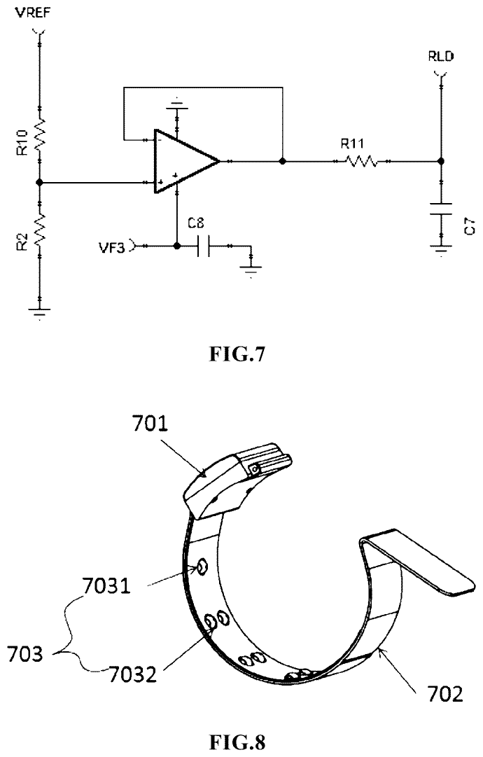

As shown in FIG. 7, the right-leg circuit includes a second operational amplifier and a fourth filter circuit. A first input end of the second operational amplifier is connected to a reference voltage input end VREF of the right-leg circuit, an output end of the second operational amplifier is connected to a first end of the fourth filter circuit, a second end of the fourth filter circuit is connected to an output end RLD of the right-leg circuit, and a second input end of the operational amplifier is connected to the output end of the second operational amplifier.

A power supply end of the second operational amplifier is connected to a third voltage input end VF3, and the power supply end of the second operational amplifier is grounded via a capacitor C8. The first input end of the second operational amplifier is grounded via a pull-down resistor R2, and a resistor R1 is provided between the second input end of the second operational amplifier and the reference voltage input end VREF.

The output end RLD of the right-leg circuit may be a metal electrode, which is attached to the user's skin when in use, and the right-leg circuit applies the bias voltage to the user's skin through the metal electrode.

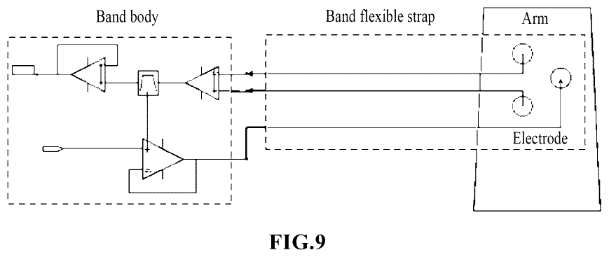

As shown in FIG. 8, the myoelectric signals acquisition apparatus may be a wearable device, such as bands, watches, rings, gloves and so on, and it includes a band body 701 and a strap 702. The strap 702 is provided with a plurality of sets of electrodes 703, which are made of a skin-friendly, flexible material and can be snugly fitted to the skin for acquiring signals at a plurality of positions. The strap 702 has a stretch characteristic and is detachable from the band body 701. The electrodes 703 include a reference electrode 7031 and a sampling electrode 7032, the sampling electrode 7032 is used to acquire the myoelectric signals, and the reference electrode 7031 is used to apply the bias voltage to the skin in the process of acquiring the myoelectric signals.

As shown in FIG. 9, the electrodes provided on the strap are connected to the circuit in the band body through wires, and they together constitute the myoelectric signals acquisition circuit according to the embodiment of the present disclosure. When in use, the electrode is attached to the surface of the user's arm to obtain the myoelectric signals.

Yet another embodiment of the present disclosure provides an electronic device including a processor and a memory, the memory storing a program or an instruction executable by the processor, the program or instruction, when executed by the processor, being capable of achieving following method for controlling myoelectric signals acquisition apparatus:
obtaining myoelectric signals from a plurality of positions on a wrist; determining whether the myoelectric signals indicate a motion holding state; when in the motion holding state, determining whether the myoelectric signals contain motion information; when determining that the myoelectric signals contain motion information, obtaining a corresponding control motion based on the myoelectric signals

Further, the program or instruction, when executed by the processor, is further capable of achieving following control method:
obtaining a first window signal from the myoelectric signals through a sliding window;
calculating a first mean value of amplitudes and a first zero-crossing rate of the first window signal;
if the first mean value exceeds a first threshold and the first zero-crossing rate exceeds a second threshold, it is determined to be in the motion holding state.

Further, the program or instruction, when executed by the processor, is further capable of achieving following control method:
obtaining a second window signal from the myoelectric signals through the sliding window; wherein the second window signal is a signal subsequent to the first window signal in chronological order;
calculating a second mean value of amplitudes and a second zero-crossing rate of the second window signal;
if the second mean value exceeds a third threshold and the second zero-crossing rate exceeds a fourth threshold, determining that the myoelectric signals contain motion information.

For the contents that can be executed by other electronic devices through programs, please refer to the method embodiments of the present disclosure, which will not be repeated herein.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, comprising an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, comprising a local area network (LAN) or a wide area network (WAN), or the connection may be made to an external computer (for example, through the Internet using an Internet Service Provider). In some embodiments, electronic circuitry comprising, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture comprising instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. It is well-known to a person skilled in the art that the implementations of using hardware, using software or using the combination of software and hardware can be equivalent.

Embodiments of the present disclosure have been presented for purposes of illustration, but are not intended to be exhaustive or limited to the embodiments disclosed. Numerous modifications and changes will be apparent to those skilled in the art without departing from the scope and spirit of the illustrated embodiments. The terminology used herein was chosen to best explain the principles of the embodiments, the practical application or technical improvement over technologies found in the marketplace, or to enable others of ordinary skill in the art to understand the embodiments disclosed herein. The scope of the present disclosure is defined by the appended claims.

1. A method for controlling a myoelectric signals acquisition apparatus, comprising:
obtaining myoelectric signals from a plurality of positions on a wrist;
determining whether a motion holding state is present, based on the mvoelectric signals;
determining whether the myoelectric signals contain motion information when in the motion holding state;
obtaining a corresponding control motion based on the myoelectric signals when the mvoelectric signals contain the motion information; and
generating a control signal based on the control motion to control a target device.

2. The method according to claim 1, wherein the determining whether a motion holding state is present, based on the mvoelectric signals comprises:
obtaining a first window signal from the myoelectric signals through a sliding window;
calculating a first mean amplitude and a first zero-crossing rate of the first window signal;
determining that the motion holding state is present if the first mean amplitude exceeds a first threshold and the first zero-crossing rate exceeds a second threshold.

3. The method according to claim 2, wherein the determining whether the myoelectric signals contain motion information when in the motion holding state comprises:
obtaining a second window signal from the myoelectric signals through the sliding window; wherein the second window signal is a signal subsequent to the first window signal in chronological order;
calculating a second mean amplitude and a second zero-crossing rate of the second window signal;
determining that the myoelectric signals contain motion information if the second mean amplitude exceeds a third threshold and the second zero-crossing rate exceeds a fourth threshold.

4. The method according to claim 1, wherein before the determining whether a motion holding state is present, based on the mvoelectric signals, the method further comprises:
estimating noise of the myoelectric signals to obtain an initial noise value;
performing a fast Fourier transform on the myoelectric signals and calculating a signal-to-noise ratio based on a fast Fourier transform result and the initial noise value;
calculating a denoising coefficient based on the signal-to-noise ratio; and
removing noise from the myoelectric signals based on the denoising coefficient.

5. The method according to claim 1, wherein the obtaining a corresponding control motion based on the myoelectric signals, comprises:
performing a dimensionality expansion on the myoelectric signals to obtain dimensionality-expanded myoelectric signals;
obtaining a corresponding control motion based on the dimensionality-expanded myoelectric signals.

6. The method according to claim 5, wherein the performing a dimensionality expansion on the myoelectric signals to obtain dimensionality-expanded myoelectric signals, comprises:
performing a short-time Fourier transform or wavelet transform on data of each of channels of the myoelectric signals to obtain frequency-domain information of the myoelectric signals;
obtaining the dimensionality-expanded myoelectric signals based on spatial information of the channels, frequency-domain information of the myoelectric signals, and time-domain information of the myoelectric signals.

7. The method according to claim 5, wherein the obtaining a corresponding control motion based on the dimensionality-expanded myoelectric signals, comprises:
recognizing the dimensionality-expanded myoelectric signals based on a preset recognition model to obtain the control motion.

8. The method according to claim 1, wherein said the obtaining myoelectric signals from a plurality of positions on a wrist, comprises:
applying a bias voltage to a skin surface;
obtaining the myoelectric signals from the plurality of positions on the wrist during applying the bias voltage.

9. A myoelectric signals acquisition apparatus, comprising a myoelectric signals acquisition circuit that comprises:
an amplification circuit, a conversion circuit, a processor, and a communication circuit;
wherein the amplification circuit is configured for receiving myoelectric signals and generating an amplified signal based on the myoelectric signals;
the conversion circuit comprises an analog-to-digital converter, with a first end thereof configured for receiving the amplified signal; and a second end thereof configured for outputting a digital signal generated by the analog-to-digital converter based on the amplified signal;
a first end of the processor is configured for receiving the digital signal, and a second end of the processor is configured for outputting a control signal generated by the processor based on the digital signal;
the processor is configured for determining whether the myoelectric signals indicate a motion holding state; when in the motion holding state, determining whether the myoelectric signals contain motion information; when determining that the myoelectric signals contain motion information, obtaining a corresponding control motion based on the myoelectric signals; generating a control signal based on the control motion;
a first end of the communication circuit is configured for receiving the control signal, and a second end of the communication circuit is configured for sending the control signal to a target device.

10. The apparatus according to claim 9, wherein the amplification circuit comprises:
a first amplification circuit with an input end thereof for receiving the myoelectric signals;
a first filter circuit with; an input end thereof for being connected to an output end of the first amplification circuit;
a second amplification circuit with an input end thereof for being connected to an output end of the first filter circuit and an output end thereof for being connected to a first end of the analog-to-digital converter.

11. The apparatus according to claim 10, wherein the first amplification circuit comprises an instrumentation amplifier, a first signal input end, and a second signal input end;
the first signal input end and the second signal input end are configured for acquiring myoelectric signals, a first end and a second end of the instrumentation amplifier are respectively connected to the first signal input end and the second signal input end, and an output end of the instrumentation amplifier is connected to an output end of the first amplification circuit.

12. The apparatus according to claim 10, wherein the filter circuit comprises a band-pass filter circuit that comprises: a first resistor, a second resistor, a first filter capacitor, and a second filter capacitor;
a first end of the first filter capacitor is connected to the output end of the first amplification circuit, a second end of the first filter capacitor is connected to both a first end of the first resistor and a first end of the second resistor, the second filter capacitor is provided between a second end of the first resistor and a second end of the second resistor, the second end of the first resistor is connected to a reference voltage input end of the band-pass filter circuit, and the second end of the second resistor is connected to an output end of the band-pass filter circuit.

13. The apparatus according to claim 10, wherein the second amplification circuit comprises a first operational amplifier, a second filter circuit, a third filter circuit, and a first voltage input end;
a first input end of the first operational amplifier is connected to the output end of the first filter circuit, a second input end of the first operational amplifier is connected to both a first end of the second filter circuit and the first voltage input end, a second input end of the second filter circuit is connected to an output end of the first operational amplifier, the output end of the first operational amplifier is connected to a first end of the third filter circuit, and a second end of the third filter circuit is connected to the output end of the second amplification circuit.

14. The apparatus according to claim 13, wherein the third filter circuit comprises a third resistor and a third capacitor, a first end of the third resistor is connected to the output end of the first operational amplifier, a second end of the third resistor is connected to a first end of the third capacitor, a second end of the third capacitor is grounded, and the first end of the third capacitor is connected to the output end of the second amplification circuit.

15. The apparatus according to claim 13, wherein the second filter circuit comprises a fourth resistor and a fourth capacitor which are connected in parallel, a first end of the fourth resistor is connected to the second input end of the first operational amplifier, and a second end of the fourth resistor is connected to the output end of the first operational amplifier.

16. The apparatus according to claim 9, wherein the myoelectric signals acquisition circuit further comprises a right-leg circuit configured for applying a bias voltage to a skin surface, and comprises a second operational amplifier and a fourth filter circuit;
a first input end of the second operational amplifier is connected to a reference voltage input end of the right-leg circuit, an output end of the second operational amplifier is connected to a first end of the fourth filter circuit, a second end of the fourth filter circuit is connected to an output end of the right-leg circuit, and a second input end of the second operational amplifier is connected to the output end of the second operational amplifier.

17. The apparatus according to claim 9, wherein the apparatus is a wearable device, which comprises a band body and a strap removably connected to the band body;
a surface of the strap is provided with a plurality of sets of electrodes, which are connected to a circuit inside the band body through wires provided in the strap, such that the circuit is formed as the myoelectric signals acquisition circuit.

18. An electronic system comprising a processor and a memory, the memory storing a program or an instruction executable by the processor, the program or instruction, when executed by the processor, configured for controlling a myoelectric signals acquisition apparatus by:
obtaining myoelectric signals from a plurality of positions on a wrist;
determining whether a motion holding state is present, based on the myoelectric signals;
determining whether the myoelectric signals contain motion information when in the motion holding state;
obtaining a corresponding control motion based on the myoelectric signals when the myoelectric signals contain the motion information; and
generating a control signal based on the control motion to control a target device.

19. The system according to claim 18, further comprising:
obtaining a first window signal from the myoelectric signals through a sliding window;
calculating a first mean amplitude and a first zero-crossing rate of the first window signal;
determining that the motion holding state is present if the first mean amplitude exceeds a first threshold and the first zero-crossing rate exceeds a second threshold.

20. The system according to claim 19, further comprising:
obtaining a second window signal from the myoelectric signals through the sliding window; wherein the second window signal is a signal subsequent to the first window signal in chronological order;
calculating a second mean amplitude and a second zero-crossing rate of the second window signal;
if the second mean amplitude exceeds a third threshold and the second zero-crossing rate exceeds a fourth threshold, determining that the myoelectric signals contain motion information.
